(19) United States
(12) Patent Application Publication
(10) Pub. No.: US 2007/0014203 A1
(43) Pub. Date: Jan. 18, 2007

(54) Apparatus and method for detecting wobble signal in disc drive using phase control

(76) Inventor: Byung-Ki Moon, Yongin-si (KR)

Correspondence Address: LAW OFFICE OF MONICA H CHOI, P O BOX 3424, DUBLIN, OH, 430160204, US

(21) Appl. No.: 11/481,624

(22) Filed: Jul. 6, 2006

(30) Foreign Application Priority Data
Jul. 12, 2005 (KR) 2005-62908

(51) Int. Cl. G11B 7/00

(52) U.S. Cl. 369/44.13

(57) ABSTRACT

For detecting a wobble signal in a disc drive, at least one delay cell adjusts a phase relationship between first and second signals from a pickup of the disc drive, for minimizing a phase difference between the first and second signals. A subtractor generates the wobble signal from a difference between the first and second signals having the adjusted phase relationship such that high frequency noise is minimized in the wobble signal.

### BACKGROUND OF THE INVENTION

This application claims priority to Korean Patent Application No. 2005-62908, filed on Jul. 12, 2005 in the Korean Intellectual Property Office, the disclosure of which is incorporated herein in its entirety by reference.

### 1. Field of the Invention

The present invention relates generally to disc drives such as optical disc drives, and more particularly, to using phase control for detecting a wobble signal with minimized noise.

### 2. Description of the Related Art

In general, optical disc drives are categorized into two types: those capable of only reproducing data from discs such as a CD-ROM, and those capable of recording data on and reproducing data from discs such as a CD-RW and a DVD-RW. A recordable optical drive uses a detected wobble signal for obtaining information related to addressing for a blank optical disc (i.e., information regarding track position).

FIG. 1 illustrates a conventional optical disc 100 with tracks and sectors. Referring to FIG. 1, each of the sectors, which are units in which information is recorded on the optical disc 100, includes an identification part 110 and a track part 120. The sectors illustrated in FIG. 1 are enlarged for clarity of illustration, but in actuality the length of each sector is only several millimeters and increases from the center radius toward the outer radius.

The identification part 110 contains identification information regarding the location of each sector, and each track of the track part 120 contains audio/video data or the like. The location of each track in the track part 120 wobbles by a small amount with an amplitude of several tens of nanometers in a radial direction of the optical disc 100. A wobble signal reflects such wobbling of each track, and the frequency of the wobble signal varies according to the length of each sector.

FIG. 2 is a block diagram of a conventional optical disc drive 200. Referring to FIG. 2, the optical disc drive 200 includes a spindle motor 210, a sled motor 220, a pickup 230, a servo controller 240, a reproducing and recording unit 250, a wobble signal detector 260, and a system controller 270.

An optical disc is loaded and rotated about a rotation axis of the spindle motor 210. The pickup 230 is moved from side to side along a radial direction of the optical disc by the sled motor 220. The pickup 230 reads data from or records encoded data on the optical disc under control of the servo controller 240 that drives tracking and focusing actuators of the pickup 230. The system controller 270 controls the spindle motor 210, the sled motor 220, and the servo controller 240 for tracking control.

Audio/video information may be recorded in the form of pits on spiral tracks of an optical disc such as that shown in FIG. 1. An optical device of the pickup 230 searches for a desired one of the tracks and generates a radio frequency (RF) signal from the information recorded on the desired track during a read operation. Also, the pickup 230 receives and processes encoded data from the reproducing and recording unit 250 for recording such data on tracks of the optical disc in the form of pits using a laser diode during a write operation.

The system controller 270 transmits decoded data from the reproducing and recording unit 250 to a host computer. In addition, the system controller 270 writes data received from the host computer to the reproducing and recording unit 250. The system controller 270 exchanges such data through an interface with the host computer.

The wobble signal detector 260 processes RF signals received from the pickup 230 to generate a wobble signal WOBB. As illustrated in FIG. 3, the RF signals used to generate the wobble signal WOBB are comprised of an AD signal and a BC signal. The AD signal is a combination (such as a sum for example) of signals picked up by optical devices A and D situated at diagonally opposite corners of the optical pickup 230. The BC signal is a combination (such as a sum for example) of signals picked up by optical devices B and C situated at diagonally opposite corners of the optical pickup 230.

The wobble signal detector 260 amplifies the AD and BC signals to predetermined levels, and generates the wobble signal WOBB using the difference between the amplified AD and BC signals. The wobble signal WOBB is used as location information of a track that the system controller 270 is searching for, and as a basic signal to generate a timing clock signal during a write operation.

FIG. 4 illustrates an example of a wobble signal 410 detected according to the prior art. Referring to FIG. 4, the wobble signal 410 includes a low-frequency component 420 mixed with a high frequency component (which is typically noise). In FIG. 4, the detected wobble signal 410 is illustrated as a pair of differential signals. In an ideal-case scenario, a wobble signal containing only the low frequency component 420 is detected.

However, because the AD and BC signals follow two different paths as illustrated in FIG. 3, the high-frequency noise component is also detected in the wobble signal 410. The phase difference between the amplified AD and BC signals may be caused by an offset or difference in frequency characteristics between the amplifiers, differences in length between connecting metal lines, or differences between parasitic capacitances, in the two paths.

Such a phase difference may be ignored for low-speed operation, but not for high-speed operation. For instance, a general optical disc drive is required to operate at a high speed, e.g., at a 16× speed, for an operating frequency of about 80 MHz. In that case, the period of a system clock signal is approximately 12.5 nano-seconds, and a wobble signal containing noise, such as the wobble signal 410 of FIG. 4, is generated due to a phase difference of even several nano-seconds.

### SUMMARY OF THE INVENTION

Accordingly, embodiments of the present invention minimize the phase difference between the AD and BC signals for reducing noise in the wobble signal.

For detecting a wobble signal in a disc drive, at least one delay cell adjusts a phase relationship between first and second signals from a pickup of the disc drive, for minimizing a phase difference between the first and second signals. In addition, a subtractor generates the wobble signal from a difference between the first and second signals having the adjusted phase relationship.

In an example embodiment of the present invention, the disc drive is an optical disc drive. In that case, the first signal is a first radio-frequency signal generated by combining device signals from A and D optical devices having areas situated diagonally opposite each-other on the pickup. In addition, the second signal is a second radio-frequency signal generated by combining device signals from B and C optical devices having areas situated diagonally opposite each-other on the pick-up.

In another embodiment of the present invention, amplifying units amplify the first and second signals before the at least one delay cell adjusts the phase relationship between the first and second signals that have been amplified.

In a further embodiment of the present invention, a controller generates at least one control signal that indicates a respective amount of phase delay for each of the at least one delay cell. In that case, each of the at least one delay cell delays a respective one of the first and second signals for adjusting the phase relationship.

In another aspect of the present invention, the controller includes a respective register that stores a respective control signal that indicates the respective amount of phase delay for each of the at least one delay cell.

In one example embodiment of the present invention, the respective control signal is determined by a user.

In another embodiment of the preset invention, the respective control signal is automatically determined from the first and second signals. For example, comparators generate first and second digitized signals from the first and second signals, and a logic unit generates a phase indicating signal from the first and second digitized signals. An integrator integrates the phase indicating signal for determining the respective control signal for each of the at least one delay cell. Alternatively, a counter counts a number of clock cycles for each pulse of the phase indicating signal for determining the respective control signal for each of the at least one delay cell.

In a further embodiment of the present invention, the respective control signal is determined in feed-back with the generated wobble signal. For example, a high pass filter passes through a high-frequency component of the generated wobble signal. Thereafter, a peak detector determines the respective control signal for each of the at least one delay cell from a peak-to-peak value of the high-frequency component of the generated wobble signal.

In another aspect of the present invention, a band-pass filter passes a frequency-band component of the wobble signal, and a comparator generates a digitized wobble signal from the frequency-band component of the wobble signal. In addition, a phase-locked loop generates a final wobble signal locked to a predetermined frequency of the digitized wobble signal.

In this manner, by reducing the phase difference between the signals used for generating the wobble signal, high-frequency noise is reduced in the wobble signal.

### BRIEF DESCRIPTION OF THE DRAWINGS

The above and other features and advantages of the present invention will become more apparent when described in detailed exemplary embodiments thereof with reference to the attached drawings in which:

FIG. 1 illustrates a conventional optical disc with sectors;

FIG. 2 is a block diagram of a conventional optical disc drive;

FIG. 3 illustrates a conventional method of detecting a wobble signal;

FIG. 4 illustrates an example of a wobble signal detected according to the conventional method;

FIG. 5 is a block diagram of an apparatus for detecting a wobble signal with reduced noise, according to an embodiment of the present invention;

FIG. 6 is a block diagram of a basic wobble extracting unit of FIG. 5, according to an embodiment of the present invention;

FIG. 7 illustrates an example of a wobble signal detected by the basic wobble extracting unit of FIG. 6, according to an embodiment of the present invention;

FIG. 8 shows a block diagram of a controller having user-determined control signals for delay cells of FIG. 6, according to an embodiment of the present invention;

FIG. 9 shows a block diagram of a controller with automatically determined control signals for the delay cells of FIG. 6, according to another embodiment of the present invention;

FIG. 10 is a waveform diagram of signals in the controller of FIG. 9, according to an embodiment of the present invention;

FIG. 11 shows a block diagram of a controller with automatically determined control signals for the delay cells of FIG. 6, according to another embodiment of the present invention; and

FIG. 12 shows a block diagram of a controller with control signals determined in feed-back for the delay cells of FIG. 6, according to an embodiment of the present invention.

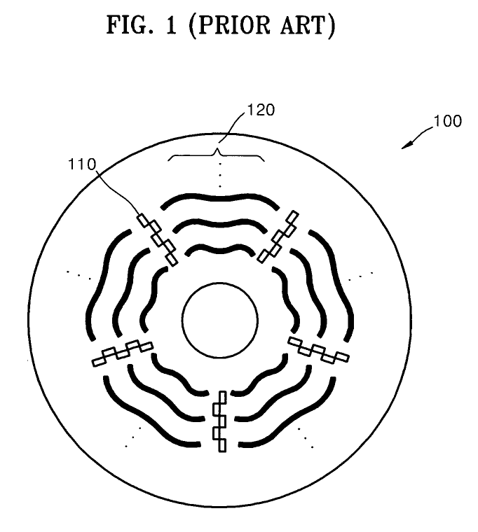

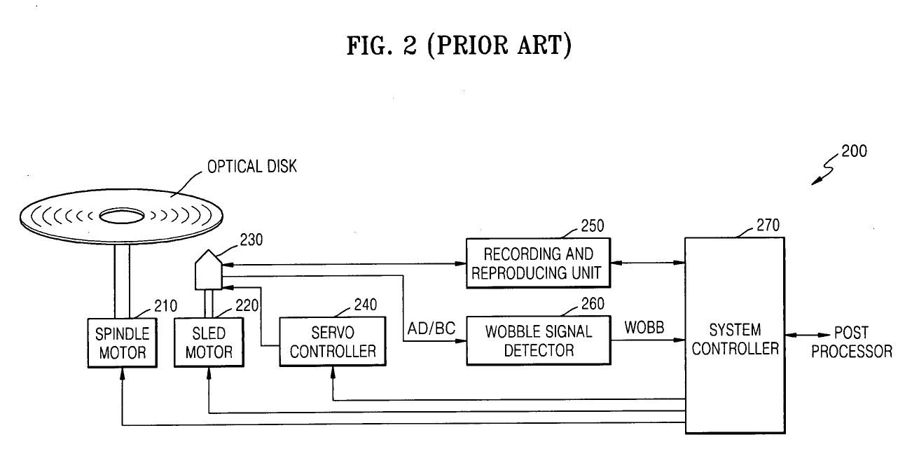

The figures referred to herein are drawn for clarity of illustration and are not necessarily drawn to scale. Elements having the same reference number in FIGS. 1, 2, 3, 4, 5, 6, 7, 8, 9, 10, 11, and 12 refer to elements having similar structure and/or function.

### DETAILED DESCRIPTION OF THE INVENTION

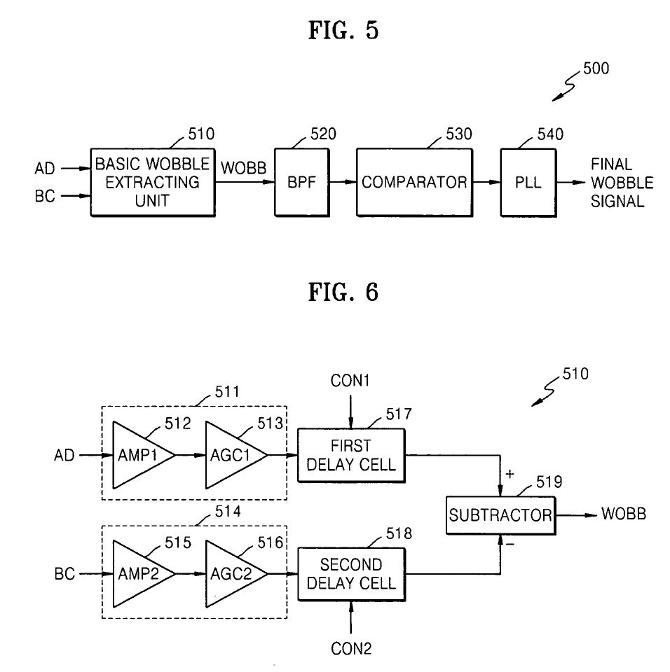

FIG. 5 is a block diagram of an apparatus 500 for detecting a wobble signal in an optical disc drive according to an embodiment of the present invention. The present invention is described for an optical disc drive, but the present invention may also be used in other types of disc drives.

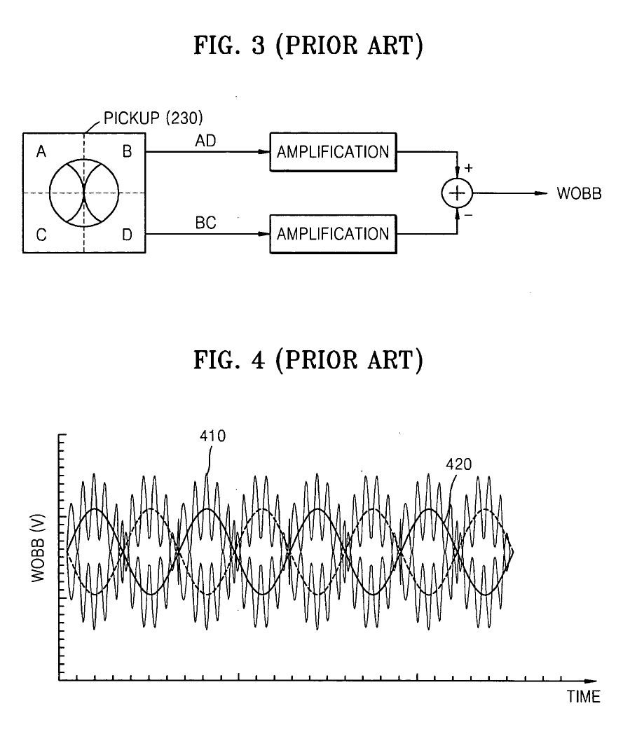

Referring to FIG. 5, the apparatus 500 includes a basic wobble extracting unit 510, a band-pass filter (BPF) 520, a comparator 530, and a phase-locked loop (PLL) 540. The basic wobble extracting unit 510 receives an AD signal and a BC signal, which are RF (radio-frequency) signals, from a pickup of the optical disc drive. For example, such a pickup is similar to the pickup 230 of FIG. 3.

In that case, the AD signal is a combination (such as a sum for example) of signals picked up by optical devices A and D situated at diagonally opposite corners of the optical pickup (such as the pickup 230 individually of FIG. 3 for example). The BC signal is a combination (such as a sum for example) of signals picked up by optical devices B and C situated at diagonally opposite corners of the optical pickup (such as the pickup 230 individually of FIG. 3 for example).

The basic wobble extracting unit 510 generates a basic wobble signal WOBB from the AD and BC signals. The basic wobble extracting unit 510 will be described later in further detail with reference to FIG. 6.

The BPF 520 removes noise from the basic wobble signal WOBB by passing a predetermined frequency-band component of the basic wobble signal WOBB. The comparator 530 generates a binary digitized wobble signal from the frequency-band component of the basic wobble signal WOBB. The PLL 540 generates a final wobble signal locked to a predetermined frequency from the binary digitized wobble signal.

The final wobble signal is used as location information for a track of the optical disc that a system controller of the disc drive is searching for. In addition, the final wobble signal is used as a basic signal to generate a timing clock signal during a write operation.

FIG. 6 shows a block diagram of the basic wobble extracting unit 510 of FIG. 5, according to an embodiment of the present invention. Referring to FIG. 6, the basic wobble extracting unit 510 includes a first amplifying unit 511, a second amplifying unit 514, a first delay cell 517, a second delay cell 518, and a subtractor 519.

The first amplifying unit 511 includes a first amplifier 512 and a first automatic gain controller (AGC) 513. The first amplifier 512 pre-amplifies the AD signal of FIG. 3, and the first AGC 513 adjusts the amplitude of the signal from the first amplifier 512 to a predetermined level, and outputs an amplified AD signal.

The second amplifying unit 514 is similar to the first amplifying unit 511 and includes a second amplifier 515 and a second AGC 516. The second amplifier 515 pre-amplifies the BC signal, and the second AGC 516 adjusts the amplitude of the signal from the second amplifier 515 to a predetermined level, and outputs an amplified BC signal.

In an embodiment of the present invention, the phase difference between the amplified AD and BC signals is minimized by first and second delay cells 517 and 518 for reducing the high-frequency noise component of the wobble signal WOBB. The first delay cell 517 phase-adjusts the amplified AD signal to a subtractor 519 by a first amount of phase-shift as indicated by a first control signal CON1. The second delay cell 518 phase-adjusts the amplified BC signal to the subtractor 519 by a second amount of phase-shift as indicated by a second control signal CON2.

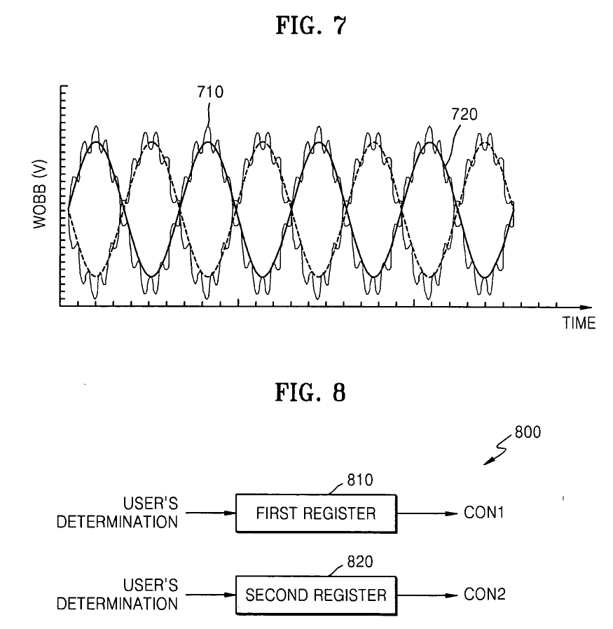

The subtractor 519 generates the wobble signal WOBB from a difference between the phase-adjusted AD and BC signals from the first and second delay cells 517 and 518. FIG. 7 is a timing diagram of an example wobble signal WOBB 710 generated from the subtractor 519. The wobble signal WOBB 710 of FIG. 7 is clearer with less noise than the wobble signal 410 of FIG. 4. The wobble signal WOBB 710 of FIG. 7 includes some high-frequency noise that can be further removed when the phase difference between the AD and BC signals are even further reduced.

The phase difference between the AD and BC signals may be generated by an offset or difference in frequency characteristics between amplifiers, a difference in length between connecting metal lines, or a difference between parasitic capacitances, for the two different paths of the AD and BC signals. Such a phase difference between the AD and BC signals is minimized for reducing the high-frequency noise component of the wobble signal WOBB. A clear basic wobble signal WOBB with reduced noise advantageously reduces input jitter in the PLL 540 in FIG. 5 thereby enabling precise and fast frequency-locking by the PLL 540.

Generation of the control signals CON1 and CON2 for indicating the amounts of phase delay in the first and second delay cells 517 and 518 is now described. FIG. 8 shows a block diagram of a controller 800 for providing the control signals CON1 and CON2 according to one embodiment of the present invention. Referring to FIG. 8, the control circuit 800 includes a first register 810 that stores a first value of the first control signal CON1, and includes a second register 820 that stores a second value of the second control signal CON2.

Such values as stored in the first and second registers 810 and 820 may be set by a user. In that case, the user empirically determines such values that results in a clear wobble signal WOBB, and the user stores such values into the registers 810 and 820.

For example, assume that the amplified AD signal to the first delay cell 517 is ahead of the amplified BC signal to the second delay cell 518. In that case, the values for the first and second control signals CON1 and CON2 stored into the registers 810 and 820, respectively, are such that the first delay cell 517 delays the amplified AD signal from the first amplifying unit 511 and such that the second delay cell 518 advances the amplified BC signal from the second amplifying unit 514. Such opposite phase adjustments may be achieved by setting the values of the CON1 and CON2 signals to have opposite polarity or by implementing the delay cells 517 and 518 to operate with opposite phase adjustment.

On the other hand, assume that the amplified AD signal to the first delay cell 517 lags the amplified BC signal to the second delay cell 518. In that case, the values for the first and second control signals CON1 and CON2 are such that the first delay cell 517 advances the amplified AD signal from the first amplifying unit 511 and such that the second delay cell 518 delays the amplified BC signal from the second amplifying unit 514.

Alternatively, only one of the first and second registers 810 and 820 may be used. For instance, when only the first register 810 is used, the phase of the amplified AD signal from only the first amplifying unit 511 is delayed or advanced by the first delay cell 517 according to the value of the CON1 signal. The phase of the amplified BC signal from the second amplifying unit 514 is not adjusted by the second delay cell 518. In that case, the phase-adjusted AD signal from the first delay cell 517 is input to the subtractor 519, and the amplified BC signal is input to the subtractor 519 directly from the second amplifying unit 514.

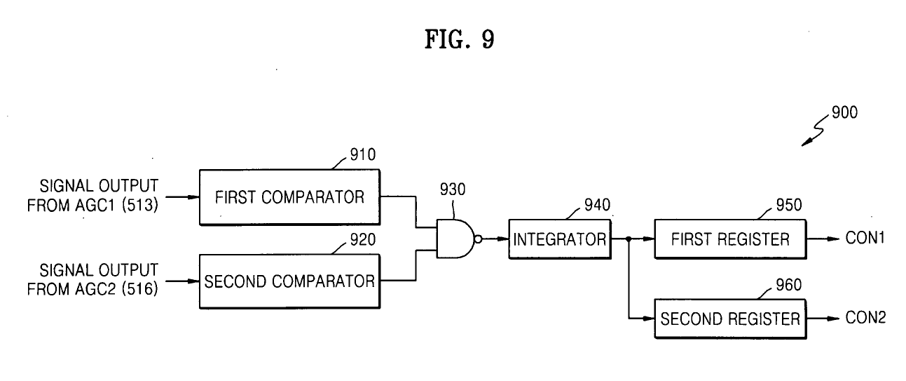

FIG. 9 illustrates a controller 900 for automatically generating the control signals CON1 and CON2, according to another embodiment of the present invention. Referring to FIG. 9, the controller 900 includes a first comparator 910, a second comparator 920, a NAND logic unit 930, an integrator 940, a first register 950, and a second register 960.

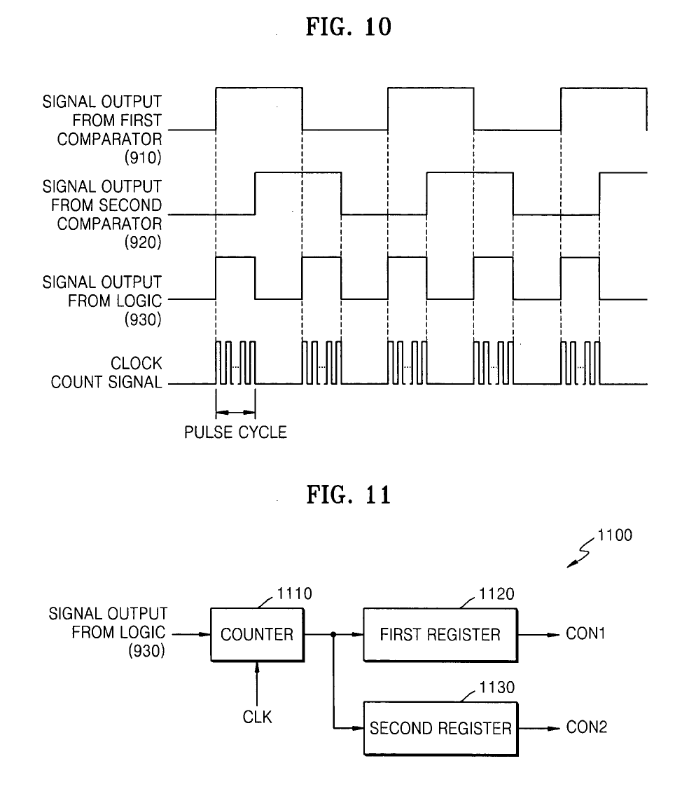

FIG. 10 shows a timing diagram of signals in the controller 900 of FIG. 9, including signals output from the first comparator 910, the second comparator 920, and the NAND logic unit 930. Referring to FIGS. 6, 9, and 10, the first comparator 910 generates a digitized AD signal using the amplified AD signal from the first amplifying unit 511. The first comparator 910 compares values of such an amplified AD signal with a threshold to output a logic high level when the amplified AD signal is greater than the threshold and to output a logic low level when the amplified AD signal is less than the threshold. The second comparator 920 similarly generates a digitized BC signal using the amplified BC signal from the second amplifying unit 514.

The NAND logic unit 930 receives the digitized AD and BC signals from the first and second comparators 910 and 920 to perform a NAND operation with such signals to generate a phase indicating signal as illustrated in FIG. 10. The integrator 940 integrates the phase indicating signal from the NAND logic 930 to generate a value indicating the phase difference between the AD and BC signals.

The first and second registers 950 and 960 set values stored therein for the control signals CON1 and CON2 according to the value as generated by the integrator 940 for minimizing the phase difference between the AD and BC signals. Similar to the embodiment of FIG. 8, any combination of the first and second registers 950 and 960 may be used for phase-adjusting any combination of the AD and BC signals, as long as the phase difference between the AD and BC signals is minimized.

FIG. 11 shows a block diagram of a controller 1100 for automatically generating the control signals CON1 and CON2, according to another embodiment of the present invention. The controller 1100 includes the first and second comparators 910 and 920 and the NAND logic unit 930 of FIG. 9. The control circuit 1100 further includes a counter 1110, a first register 1120, and a second register 1130. Thus, the controller 1100 of FIG. 11 includes the counter 1110 instead of the integrator 940 of FIG. 9.

Referring to FIGS. 10 and 11, the counter 1110 counts a number of cycles of a clock signal CLK occurring within each pulse of the signal output from the NAND logic unit 930. The counter further generates a count value from such a count for indicating a phase difference between the AD and BC signals. The first and second registers 1120 and 1130 set values stored therein for the control signals CON1 and CON2 according to the count value as generated by the counter 1110 for minimizing the phase difference between the AD and BC signals. Similar to the embodiment of FIG. 8, any combination of the first and second registers 1120 and 1130 may be used for phase-adjusting any combination of the AD and BC signals, as long as the phase difference between the AD and BC signals is minimized.

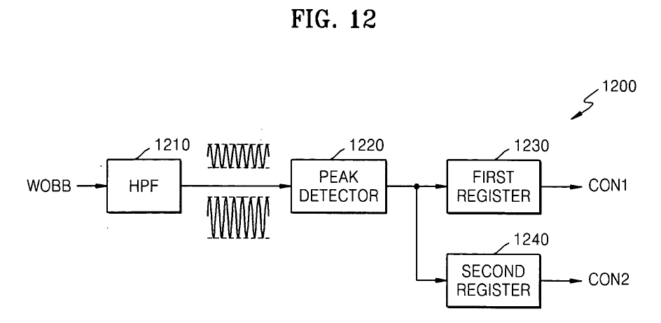

FIG. 12 shows a block diagram of a controller 1200 for generating the control signals CON1 and CON2 with feed-back, according to another embodiment of the present invention. The controller 1200 includes a high-pass filter (HPF) 1210, a peak detector 1220, a first register 1230, and a second register 1240.

Referring to FIGS. 6 and 12, the wobble signal WOBB generated by the subtractor 519 is input by the HPF 1210 that passes through a high-frequency component of the wobble signal WOBB. A higher amplitude of such a high-frequency component of the wobble signal WOBB indicates higher phase difference between the AD and BC signals.

The peak detector 1220 generates a peak-to-peak value for the high-frequency component of the wobble signal WOBB from the HPF 1210. The first and second registers 1230 and 1240 set values stored therein for the control signals CON1 and CON2 according to the peak-to-peak value as generated by the peak detector 1220 for minimizing the phase difference between the AD and BC signals. Similar to the embodiment of FIG. 8, any combination of the first and second registers 1230 and 1240 may be used for phase-adjusting any combination of the AD and BC signals, as long as the phase difference between the AD and BC signals is minimized.

In this manner, the phase difference between the AD and BC signals are minimized for reducing high-frequency noise in the wobble signal WOBB generated from the wobble extracting unit of FIG. 6. The foregoing is by way of example only and is not intended to be limiting. For example, any numbers or number of elements described and illustrated herein is by way of example only. In addition, the present invention has been described for an optical disc drive. However, the present invention may be practiced for any other type of disc drive detecting a wobble signal.

The present invention is limited only as defined in the following claims and equivalents thereof.

What is claimed is:

1. An apparatus for detecting a wobble signal in a disc drive, the apparatus comprising:
at least one delay cell for adjusting a phase relationship between first and second signals from a pickup of the disc drive, for minimizing a phase difference between the first and second signals; and
a subtractor for generating the wobble signal from a difference between the first and second signals having the adjusted phase relationship.

2. The apparatus of claim 1, wherein the disc drive is an optical disc drive, and wherein the first signal is a first radio-frequency signal generated by combining device signals from A and D optical devices having areas situated diagonally opposite each-other on the pickup, and wherein the second signal is a second radio-frequency signal generated by combining device signals from B and C optical devices having areas situated diagonally opposite each-other on the pick-up.

3. The apparatus of claim 2, further comprising:
amplifying units for amplifying the first and second signals before the at least one delay cell adjusts the phase relationship between the first and second signals that have been amplified.

4. The apparatus of claim 1, further comprising:
a controller for generating at least one control signal that indicates a respective amount of phase delay for each of the at least one delay cell,
wherein each of the at least one delay cell delays a respective one of the first and second signals for adjusting the phase relationship.

5. The apparatus of claim 4, wherein the controller includes:
a respective register that stores a respective control signal that indicates the respective amount of phase delay for each of the at least one delay cell.

6. The apparatus of claim 5, wherein the respective control signal is determined by a user.

7. The apparatus of claim 4, wherein the respective control signal is automatically determined from the first and second signals.

8. The apparatus of claim 7, wherein the controller further includes:
comparators for generating first and second digitized signals from the first and second signals;
a logic unit for generating a phase indicating signal from the first and second digitized signals; and
an integrator for integrating the phase indicating signal for determining the respective control signal for each of the at least one delay cell.

9. The apparatus of claim 7, wherein the controller further includes:
comparators for generating first and second digitized signals from the first and second signals;
a logic unit for generating a phase indicating signal from the first and second digitized signals; and
an counter for counting a number of clock cycles for each pulse of the phase indicating signal for determining the respective control signal for each of the at least one delay cell.

10. The apparatus of claim 4, wherein the respective control signal is determined in feed-back with the generated wobble signal.

11. The apparatus of claim 10, wherein the controller further includes:
a high pass filter that passes through a high-frequency component of the generated wobble signal; and
a peak detector that determines the respective control signal for each of the at least one delay cell from a peak-to-peak value of the high-frequency component of the generated wobble signal.

12. The apparatus of claim 1, further comprising:
a band-pass filter for passing a frequency-band component of the wobble signal;
a comparator for generating a digitized wobble signal from the frequency-band component of the wobble signal; and
a phase-locked loop for generating a final wobble signal locked to a predetermined frequency of the digitized wobble signal.

13. A method of detecting a wobble signal in a disc drive, comprising:
adjusting a phase relationship between first and second signals from a pick-up of the disc drive, for minimizing a phase difference between the first and second signals; and
generating the wobble signal from a difference between the first and second signals having the adjusted phase relationship.

14. The method of claim 13, wherein the disc drive is an optical disc drive, and wherein the first signal is a first radio-frequency signal generated by combining device signals from A and D optical devices having areas situated diagonally opposite each-other on the pickup, and wherein the second signal is a second radio-frequency signal generated by combining device signals from B and C optical devices having areas situated diagonally opposite each-other on the pick-up.

15. The method of claim 14, further comprising:
amplifying the first and second signals before adjusting the phase relationship between the first and second signals that have been amplified.

16. The method of claim 13, further comprising:
generating at least one control signal that indicates a respective amount of phase delay for each of the first and second signals,
wherein each of the first and second signals is delayed by the respective amount of phase delay in the step of adjusting the phase relationship.

17. The method of claim 16, wherein the at least one control signal is determined by a user.

18. The method of claim 16, further comprising:
automatically determining the at least one control signal from the first and second signals.

19. The method of claim 18, further comprising:
generating first and second digitized signals from the first and second signals;
generating a phase indicating signal from the first and second digitized signals; and
integrating the phase indicating signal for determining the at least one control signal.

20. The method of claim 18, further comprising:
generating first and second digitized signals from the first and second signals;
generating a phase indicating signal from the first and second digitized signals; and
counting a number of clock cycles for each pulse of the phase indicating signal for determining the at least one control signal.

21. The method of claim 16, further comprising:
determining the at least one control signal in feed-back with the generated wobble signal.

22. The method of claim 21, further comprising:
filtering through a high-frequency component of the generated wobble signal; and
determining the at least one control signal from a peak-to-peak value of the high-frequency component of the generated wobble signal.

23. The method of claim 13, further comprising:
filtering through a frequency-band component of the wobble signal;
generating a digitized wobble signal from the frequency-band component of the wobble signal; and
generating a final wobble signal locked to a predetermined frequency of the digitized wobble signal.
